(19) United States
(12) Patent Application Publication
(10) Pub. No.: US 2009/0278439 A1
(43) Pub. Date: Nov. 12, 2009

(54) Lamp Tube having Bent Segments

(76) Inventor: Fan-Kuei LIANG, Hsinchu City (TW)

Correspondence Address: HDLS Patent & Trademark Services, P.O. BOX 220746, CHANTILLY, VA, 20153-0746, US

(21) Appl. No.: 12/245,833

(22) Filed: Oct. 6, 2008

(30) Foreign Application Priority Data
May 6, 2008 (TW) 097207774

(51) Int. Cl. H01J 1/62

(52) U.S. Cl. 313/493

(57) ABSTRACT

A lamp tube includes a lamp tube body, which are formed with bent segments by being heated, bent and then cooled at potions thereof desired to be bent. In this manner, luminance efficiency and lifetime of the lamp tube are effectively improved and prolonged.

### BACKGROUND OF THE INVENTION

1. Field of the Invention

The present invention relates to a lamp tube having bent segments, and particularly to a lamp tube having bent segments formed through high temperature applied onto the lamp tube body thereof and through which luminance efficiency and lifetime of the lamp tube can be effectively improved.

2. Description of the Prior Art

Lamps are still the most popular lighting means today and thus lamp tubes are widely used in almost any place. Lamp light is emitted by bringing gas discharging forth and generating ultraviolet light as electrons resulted from the gas discharging process strike mercury sealed within the lamp tube. An alternative for lighting is the use of cold cathode tube (CCFL). The cold cathode-tube is pre-coated with fluorescent powders on an inner wall thereof and a miniscule amount of mercury and kinds of inactive gases are sealed therewithin. Further, two electrodes are provided at two ends of the cold cathode tube, respectively. In operation, a high voltage is provided to one of the electrodes, with the other electrode grounded. This causes a small amount of electrons and molecules within the lamp tube forced to strike the electrodes to generate secondary electrons. When gas discharging occurs, the electrons collide with mercury in the tube, which results in ultraviolet light emitting from mercury. Sequentially, the ultraviolet light excites the fluorescent powders coated on the tube wall to generate visible light with color temperature corresponding thereto.

Some spiral lamp tubes have been successfully manufactured. However, these available lamp tubes each has some shortages contributed from the bent structure and will be described below. First, the lamp tube body has portions too close to each other and thus some portions of the light emitted therefrom are blocked by the other portions of the lamp tube body. Accordingly, luminance efficiency of such lamp tube is not satisfactory. Second, in the case of a cold cathode tube, the tube has to be heated under a certain temperature before being softened and bent to be spiral in shape. At this time, black dots are formed on the tube wall, making the lamp tube look not pleasing to the eyes. In addition, tests show such lamp tube has approximately an up-to-one-third reduction in luminance and lifetime.

In view of the above, the conventional lamp tube still has something to be improved. After a long term research and experiment, an improved lamp tube having bent segments is finally developed and taken as the present invention.

### SUMMARY OF THE INVENTION

It is an object of the present invention to provide a lamp tube having bent segments formed by heating and bending a lamp tube body of the lamp tube thereat, so as to exempt the light ray emitted from each of portions of the lamp tube body from being blocked by the other portions of the lamp tube body and thus achieve the maximum luminance efficiency.

It is an another object of the present invention to provide a lamp tube having bent segments formed by heating and bending a lamp tube body of the lamp tube thereat, so as to effectively prolong lifetime of the lamp tube.

The lamp tube having bent segments according to the present invention comprises a lamp tube body taking a straight tubular shape, the lamp tube body having a layer of fluorescent material coated on an inner wall thereof, a first and second ends each having an electrode bonded thereto, and an adequate amount of mercury and inactive gases sealed therewithin. The bent segments of the lamp tube are formed by heated, bent and then cooled.

These features and advantages of the present invention will be fully understood and appreciated from the following detailed description of the accompanying Drawings.

### BRIEF DESCRIPTION OF THE DRAWINGS

FIG. 1 is a perspective diagram of a lamp tube having bent segments according to a first embodiment of the present invention;

FIG. 2 is a perspective diagram of the lamp tube having bent segments according to a second embodiment of the present invention; and

FIG. 3 is a perspective diagram of the lamp tube having bent segments combined on a lamp seat according to the present invention.

### DETAILED DESCRIPTION OF THE PREFERRED EMBODIMENT

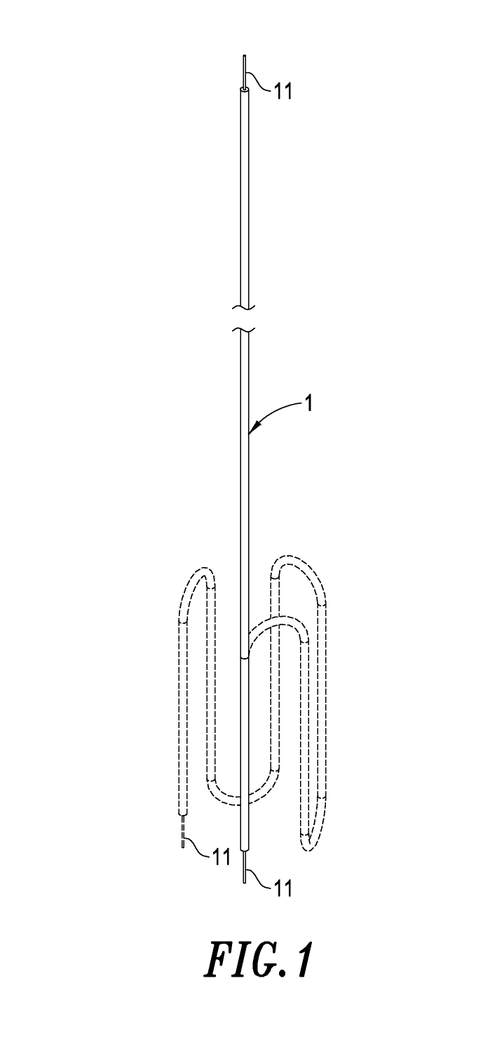

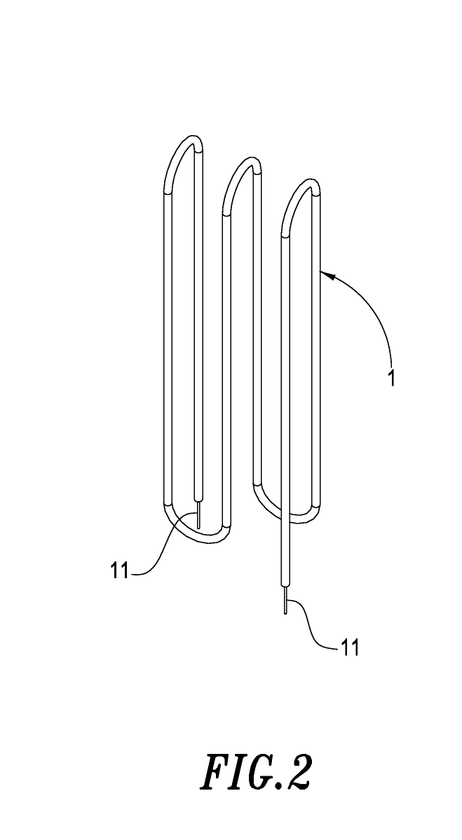

Referring to FIG. 1, a lamp tube having bent segments according to the present invention is shown therein. As shown, the lamp tube having bent segments has a lamp tube body 1, which takes a straight tubular shape. The lamp tube body 1 has an inner wall, on which a layer of fluorescent material (not shown) is pre-coated. The lamp tube body 1 further has a first and second ends, on each of which an electrode 11 is bonded thereto. An adequate amount of mercury and inactive gases is sealed within the lamp tube body 1. In this invention, the lamp tube body 1 is heated and then bent at portions desired to be bent to preliminary form the bent segments thereof. After being cooled, the lamp tube body 1 is actually formed with the bent segments. In a first embodiment, the lamp tube body 1 is bent to having a three-dimensional form (such termed herein), shown in FIG. 1. In a second embodiment, the lamp tube body 1 is bent to having another three-dimensional form, shown in FIG. 2. The lamp tube body 1 of the present invention may have other alternative embodiments, such as otherwise being bent to having a planar form, although not shown in the drawings. The form of the bent segments of the lamp tube body 1 is adopted depending upon the specific applications of the lamp tube body 1, and provision of the different forms is for wide use of the lamp tube itself.

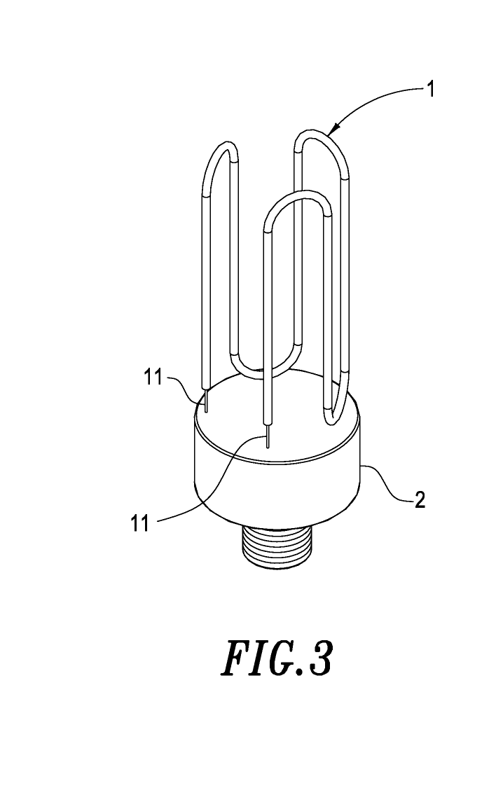

Referring to FIG. 3, a perspective diagram of the lamp tube having bent segments combined on a lamp seat according to the present invention is shown therein. The lamp tube body 1 with the bent segments is combined to a lamp seat 2 by inserted the lamp tube body 1 into the lamp seat 2 at the respective electrodes 11 thereof. As such, a lighting means is obtained and may be used on a lighting equipment.

As compared to the prior art, the lamp tube having bent segments of the present invention has the following advantages. First, the light ray emitted from each of portions of the lamp tube body can be exempted from being blocked by the other portions of the lamp tube body. Second, lifetime of the lamp tube is effectively prolonged.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A lamp tube having bent segments, comprising a lamp tube body taking a straight tubular shape, the lamp tube having a layer of fluorescent material coated on an inner wall thereof, a first and second ends each having an electrode bonded thereto, and an adequate amount of mercury and inactive gases sealed therewithin, characterized in that: the bent segments are formed by being heated, bent and then cooled.

2. The lamp tube having bent segments as claimed in claim 1, wherein the lamp tube body is bent to having a three-dimensional form.

3. The lamp tube having bent segments as claimed in claim 1, wherein the lamp tube body is bent to having a planar form.

4. The lamp tube having bent segments as claimed in claim 1, wherein the lamp tube body is combinable to a lamp seat to form a lighting means by inserting the lamp tube body into the lamp seat at the respective electrodes thereof.
